(19) United States
(12) Patent Application Publication
(10) Pub. No.: US 2006/0057367 A1
(43) Pub. Date: Mar. 16, 2006

(54) Optical film

(76) Inventors: Audrey A. Sherman, St. Paul, MN (US); Mieczyslaw H. Mazurek, Roseville, MN (US); Wendi J. Winkler, Minneapolis, MN (US); Cristina U. Thomas, Woodbury, MN (US); Kenneth J. Callahan, Shoreview, MN (US); David W. Erismann, Newport, MN (US); Raghunath Padiyath, Woodbury, MN (US); Lyudmila A. Pekurovsky, Bloomington, MN (US)

Correspondence Address: 3M INNOVATIVE PROPERTIES COMPANY, PO BOX 33427, ST. PAUL, MN, 55133-3427, US

(21) Appl. No.: 10/940,442

(22) Filed: Sep. 14, 2004

(51) Int. Cl. B32B 7/12; B32B 15/04

(52) U.S. Cl. 428/343

(57) ABSTRACT

An optical film includes an optical substrate and an adhesive first surface disposed on the optical substrate. The adhesive includes siloxane moieties at a siloxane-rich second surface of the adhesive. The adhesive increases adhesion when placed in contact with a second substrate over time. Optical film methods are also disclosed.

### BACKGROUND

This invention relates to optical films. Specifically, the invention relates to optical films that are temporarily repositionable.

To apply a polymeric film to a screen of a display device, a window, or a vehicular windshield, heat and/or photo curable adhesives are not always practical. In these applications adhesives (such as pressure sensitive adhesives, for example) are traditionally used to bond the substrates and form the laminate. Pressure sensitive adhesives do not always require a separate curing step like heat or photo curable adhesives, and may be more easily removed and/or repositioned on the substrate.

However, when the substrate and the pressure sensitive adhesive layer are adhered, it is difficult to ensure a firm and reliable bond in the laminate structure. Repositioning the polymeric film often damages the substrate and/or film. In addition, air is typically trapped at the interfaces between the adhesive and the substrate, and the resulting bubbles cause haze and compromise the optical properties of the laminate. It is inconvenient, messy, and sometimes impractical to wet a substrate with water or a plasticizer to control adhesion and allow trapped air to dissolve into the adhesive layer at the interface with the substrate. In addition, current optical film adhesive will adhere to itself and damage the optical qualities of the film when the two adhesive surfaces are pulled apart.

Structuring pressure sensitive adhesives has been described to allow air and/or fluid to escape while the film is being laminated onto a surface. These channels can be sufficiently large to allow egress of fluids to the periphery of the adhesive layer for exhaustion into the surrounding atmosphere. While these microstructured adhesives can be temporarily repositionable, the channels will close as the adhesive is laminated rendering the film when removed unusable.

### SUMMARY

Generally, the present invention relates to an optical film that includes a optical substrate and an adhesive disposed on the optical film. This invention also relates to a method of using the optical film to form optical laminates.

In one illustrative embodiment, an optical film includes an optical substrate and an adhesive disposed on the optical substrate. The adhesive has a first surface disposed on the optical substrate. The adhesive includes siloxane moieties at a siloxane-rich second surface of the adhesive. The adhesive increases adhesion when placed in contact with a second substrate over time. In some embodiments, the adhesive includes pendant monovalent siloxane moieties. In other embodiments, the adhesive includes silicone elastomer having polar moieties.

In another embodiment, a method of forming optical film laminates is disclosed. The method includes the steps of providing an optical film including an optical substrate and an adhesive having a first surface disposed on the optical substrate. The adhesive includes siloxane moieties at a siloxane-rich second surface of the adhesive. The siloxane-rich second surface can be laminated onto a second substrate to form a first composite laminate. The first composite laminate has an initial peel adhesion value. Then, the siloxane-rich second surface is allowed to remain in contact with the second substrate for a time interval. The first composite laminate has second peel adhesion value after the time interval. The second peel adhesion value is greater than the initial peel adhesion value.

The above summary of the present invention is not intended to describe each disclosed embodiment or every implementation of the present invention. The Figures, Detailed Description and Examples which follow more particularly exemplify these embodiments.

### BRIEF DESCRIPTION OF THE DRAWINGS

The invention may be more completely understood in consideration of the following detailed description of various embodiments of the invention in connection with the accompanying drawings, in which:

FIG. 1 is a schematic cross-sectional view of a microstructured adhesive on an optical substrate;

FIG. 2 is a schematic cross-sectional view of the microstructured adhesive on an optical substrate of FIG. 1 as it contacted with a second substrate;

FIG. 3 is a schematic cross-sectional view of the microstructured adhesive on an optical substrate of FIG. 1 after dry lamination to the second substrate;

FIG. 4 is a schematic cross-sectional view of the microstructured adhesive on an optical substrate of FIG. 3 being removed from the second substrate; and

FIG. 5 is a schematic cross-sectional view of the microstructured adhesive on an optical substrate of FIG. 4 being dry laminated to the second substrate.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention. The Figure elements are not drawn to any particular scale and individual elements' sizes are presented for ease of illustration.

### DETAILED DESCRIPTION

The present invention is believed to be applicable generally to an optical film that includes an optical substrate and an adhesive disposed on the optical substrate. The adhesive has a first surface disposed on the optical substrate. The adhesive includes siloxane moieties at a siloxane-rich second surface of the adhesive. The adhesive increases adhesion when placed in contact with a second substrate over time. In some embodiments, the adhesive includes pendant monovalent siloxane moieties. In other embodiments, the adhesive includes silicone elastomer having polar moieties.

This invention also relates to a method of forming optical film laminates. The method includes the steps of providing an optical film including an optical substrate and an adhesive having a first surface disposed on the optical substrate. The adhesive includes siloxane moieties at a siloxane-rich second surface of the adhesive. The siloxane-rich second surface can be laminated onto a second substrate to form a first composite laminate. The first composite laminate has an initial peel adhesion value. Then, the siloxane-rich second surface is allowed to remain in contact with the second substrate for a time interval. The first composite laminate has second peel adhesion value after the time interval. The second peel adhesion value is greater than the initial peel adhesion value.

While the present invention is not so limited, an appreciation of various aspects of the invention will be gained through a discussion of the examples provided below.

For the following defined terms, these definitions shall be applied, unless a different definition is given in the claims or elsewhere in this specification.

The term “polymer” will be understood to include polymers, copolymers, oligomers and combinations thereof, as well as polymers, oligomers, or copolymers that can be formed in a miscible blend.

The term “optical film” or “optical substrate” refers to films or substrates that are used in optical applications. Optical applications include, for example, window films (solar control, shatter protection, decoration, and the like), optical display films (glare control, scratch protection, and the like). These films or substrates manage light passing through them.

Unless otherwise indicated, all numbers expressing quantities of ingredients, properties such as molecular weight, reaction conditions, and so forth used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings of the present invention. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviations found in their respective testing measurements.

Weight percent, percent by weight, % by weight, and the like are synonyms that refer to the concentration of a substance as the weight of that substance divided by the weight of the composition and multiplied by 100.

The recitation of numerical ranges by endpoints includes all numbers subsumed within that range (e.g. 1 to 5 includes 1, 1.5, 2, 2.75, 3, 3.80, 4, and 5).

As used in this specification and the appended claims, the singular forms “a”, “an”, and “the” include plural referents unless the content clearly dictates otherwise. Thus, for example, reference to a composition containing “a compound” includes a mixture of two or more compounds. As used in this specification and the appended claims, the term “or” is generally employed in its sense including “and/or” unless the content clearly dictates otherwise.

In some embodiments of the invention, an optical film includes an optical substrate and an adhesive disposed on the optical substrate. The adhesive includes siloxane moieties at a siloxane-rich second surface of the adhesive. The adhesive increases adhesion when placed in contact with a second substrate over time. In some embodiments, the adhesive has a microstructured surface.

In some embodiments, the optical film and laminates formed with the optical film can have a value of 15% or less, 10% or less, 5% or less, 3% or less, or 1% or less, or 0 to 1%. Haze values can be measured as defined in the Methods section below.

In some embodiments, the optical film and laminates formed with the optical film can have a visible light transmission in a range of 40% or greater, 50% or greater, or 70% or greater, 80% or greater, 90% or greater, or 95% or greater. The optical film and laminates formed with the optical film can have a total solar energy rejection value in a range of 30% or greater, 35% or greater, or 40% or greater. In some of these embodiments, the optical film and laminates formed with the optical film can have a visible light transmission in a range of 40% or greater and a total solar energy rejection value in a range of 30% or greater, 35% or greater, or 40% or greater. In other embodiments, the optical film and laminates formed with the optical film can have a visible light transmission in a range of 50% or greater and a total solar energy rejection value in a range of 30% or greater, 35% or greater, or 40% or greater. In still other embodiments, the optical film and laminates formed with the optical film can have a visible light transmission in a range of 70% or greater and a total solar energy rejection value in a range of 30% or greater, 35% or greater, or 40% or greater. Visible light transmission and total solar energy rejection values can be measured as defined in the Methods section below.

The optical substrate can be any material that possesses the optical properties described above. In some embodiments, the optical substrate can be any polymeric material. A partial listing of these polymers include for example, polyolefin, polyacrylates, polyesters, polycarbonates, fluoropolymers and the like. One or more polymers can be combined to form the polymeric optical film.

In some embodiments, the adhesive can have at least one major surface having a smooth surface. In other embodiments, the adhesive can be a layer having at least one major surface with a structured topography. The microstructures on the surface of the adhesive layer can have specific shapes that allow egress of air or other fluids trapped at the interface between the adhesive and a substrate (optical or second substrate) during the lamination process. The microstructures allow the adhesive layer to be uniformly laminated to a substrate without forming bubbles that could cause imperfections in the resulting laminate (optical film or composite laminate.)

The microstructures on the adhesive layer (and corresponding microstructures on a release liner) can be microscopic in at least two dimensions. The term microscopic as used herein refers to dimensions that are difficult to resolve by the human eye without aid of a microscope. One useful definition of microscopic is found in Smith, Modern Optic Engineering, (1966), pages 104-105, wherein visual acuity is defined and measured in terms of the angular size of the smallest character that can be recognized. Normal visual acuity allows detection of a character that subtends an angular height of 5 minutes of arc on the retina.

The microstructures in the adhesive layer of the invention may be made as described in U.S. Pat. Nos. 6,197,397 and 6,123,890, which are each incorporated herein by reference. The topography may be created in the adhesive layer by any contacting technique, such as casting, coating or compressing. The topography may be made by at least one of: (1) casting the adhesive layer on a tool with an embossed pattern, (2) coating the adhesive layer onto a release liner with an embossed pattern, or (3) passing the adhesive layer through a nip roll to compress the adhesive against a release liner with an embossed pattern. The topography of the tool used to create the embossed pattern may be made using any known technique, such as, for example, chemical etching, mechanical etching, laser ablation, photolithography, stereolithography, micromachining, knurling, cutting or scoring.

A liner can be disposed on the adhesive layer or microstructured adhesive layer and may be any release liner or transfer liner known to those skilled in the art that in some cases are able of being embossed as described above. The liner can be capable of being placed in intimate contact with an adhesive and subsequently removed without damaging the adhesive layer. Non-limiting examples of liners include materials from 3M of St. Paul, Minn., Loparex, Willowbrook Ill., P.S Substrates, Inc., Schoeller Technical Papers, Inc., AssiDoman Inncoat GMBH, and P. W. A. Kunstoff GMBH. The liner can be a polymer-coated paper with a release coating, a polyethylene coated polyethylene terepthalate (PET) film with release coatings, or a cast polyolefin film with a release coating. The adhesive layer and/or release liner may optionally include additional non-adhesive microstructures such as, for example, those described in U.S. Pat. Nos. 5,296,277; 5,362,516; and 5,141,790. These microstructured adhesive layers with non-adhesive microstructures are available from 3M. St. Paul, Minn., under the trade designation Controltac Plus.

The microstructures may form a regular or a random array or pattern. Regular arrays or patterns include, for example, rectilinear patterns, polar patterns, cross-hatch patterns, cube-corner patterns. The patterns may be aligned with the direction of the carrier web, or may be aligned at an angle with respect to the carrier web. The pattern of microstructures may optionally reside on both major, opposing surfaces of the adhesive layer. This allows individual control of air egress and surface area of contact for each of the two surfaces to tailor the properties of the adhesive to two different interfaces.

The pattern of microstructures can define substantially continuous open pathways or grooves that extend into the adhesive layer from an exposed surface. The pathways either terminate at a peripheral portion of the adhesive layer or communicate with other pathways that terminate at a peripheral portion of the article. When the article is applied to a substrate, the pathways allow egress of fluids trapped at an interface between the adhesive layer and a substrate.

The shapes of the microstructures in the adhesive layer may vary widely depending on the level of fluid egress and peel adhesion required for a particular application, as well as the surface properties of the substrate. Protrusions and depressions may be used, and the microstructures may be continuous to form grooves in the adhesive layer. Suitable shapes include hemispheres, right pyramids, trigonal pyramids, square pyramids, quadrangle pyramids, and “V” grooves, for reasons of pattern density, adhesive performance, and readily available methodology for producing the microstructures. The microstructures may be systematically or randomly generated.

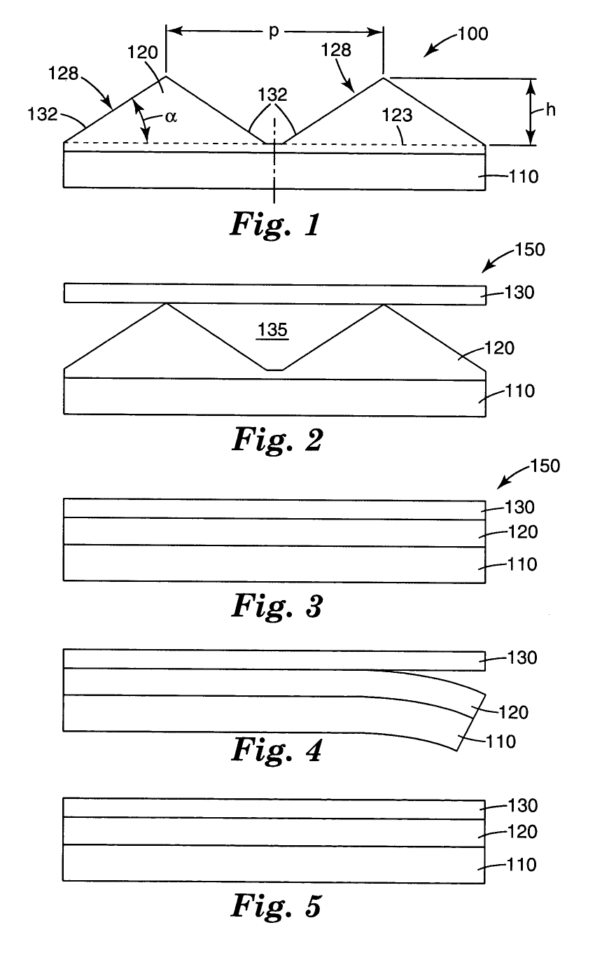

FIG. 1 is a schematic cross-sectional view of a microstructured adhesive 120 on a substrate 110. The illustrative optical film 100 includes a 120 disposed on an optical substrate 110. The embodiment shown has a plurality of pyramidal protrusions 128 extending above a plane 123 of the adhesive layer. The dimensions of the protrusions may vary widely depending on the rheology of the adhesive layer and the application conditions, and should be selected to provide adequate balance between adhesion to substrate and fluid egress. In some embodiments, the mean pitch P between selected protrusions 128 is up to 400 micrometers, or 50 to 400 micrometers, or from 100 to 350 micrometers, or from 200 to 300 micrometers. In some embodiments, the mean height h of selected protrusions 128 from the plane 123 of the adhesive layer 120 can be greater than 1 micrometer and up to 35 micrometers, or 5 to 30 micrometers. Selected protrusions 128 have at least one sidewall 132 that makes an angle \acute{α} with respect to a plane 123 of the surface of the adhesive layer 120. The angle \acute{α} can be selected from an angle greater than 5° and less than 40°, or from 5° to 15°, or from 5° to 10°.

An optional release liner (not shown) can be disposed on the adhesive 120. The release liner can have a topography that corresponds to the topography of the adhesive 120 layer. In some embodiments, the release liner can provide a low surface energy interface with the adhesive 120 which can allow siloxane moieties present in the adhesive 120 to concentrate at or near the surface interface with the release liner.

Once the release liner is removed, the exposed surface of the microstructured adhesive layer 120 may be contacted with a second substrate 130 to form a composite laminate 150. FIG. 2 is a schematic cross-sectional view of the adhesive 120 and substrate 110 of FIG. 1 as it contacts a second substrate 130 to form a composite laminate 150.

The second substrates 130 may be rigid or flexible. Examples of suitable substrates 130 include glass, metal, plastic, wood, and ceramic substrates, painted surfaces of these substrates, and the like. Representative plastic substrates include polyester, polyvinyl chloride, ethylene-propylene-diene monomer rubber, polyurethanes, polymethyl methacrylate, engineering thermoplastics (e.g., polyphenylene oxide, polyetheretherketone, polycarbonate), and thermoplastic elastomers. The second substrate may also be a woven fabric formed from threads of synthetic or natural materials such as, for example, cotton, nylon, rayon, glass or ceramic material. The second substrate may also be made of a nonwoven fabric such as air laid webs of natural or synthetic fibers or blends thereof. Preferably, the second substrate is an optical material, such as glass, clear polymeric materials and the like. The optical film can form an optical composite laminate when bonded to the second substrate.

In the illustrative embodiment, as the adhesive layer 120 initially contacts the second substrate 130, the pyramidal protrusions 128 contact the surface of the second substrate 130, and the areas 135 between the protrusions 128 function as channels for fluid egress. This allows pockets of trapped air between the adhesive layer 120 and the second substrate 130 to be easily transported to an adhesive edge.

The material forming the adhesive layer is selected such that the adhesive layer is temporarily removable and repositionable from the second substrate after lamination. By incorporating siloxane moieties within the pressure sensitive adhesive such that a siloxane-rich surface can be created on the adhesive layer, the optical film can be easily laminated and temporarily repositioned without damage to either the second substrate or the optical film. Adhesion of the adhesive layer to the second substrate builds over time to near an adhesion level the adhesive possesses without the siloxane moieties.

While not wishing to be bound by any particular theory, it is thought that the siloxane-rich surface of the adhesive is able to restructure upon contacting another surface. This restructuring may be driven by the minimization of interfacial energy.

Adhesives can include siloxane moieties that can concentrate at a low energy surface of the adhesive and form a siloxane-rich surface. Once the adhesive is laminated to another substrate, the siloxane moieties can migrate away from the siloxane-rich surface and allow adhesion between the adhesive and substrate to build as this laminate contacts the substrate over time.

Illustrative useful polysiloxane-grafted copolymer adhesive compositions are described in U.S. Pat. No. 4,693,935, which is incorporated by reference herein. This reference describes a pressure sensitive adhesive (PSA) composition including a copolymer having a vinyl polymeric backbone having grafted thereto pendent polysiloxane moieties. An exposed surface of these compositions is initially repositionable on a substrate to which it will be adhered but, once adhered, builds adhesion to form a strong bond.

These copolymers can have a vinyl polymeric backbone which has been chemically modified by the addition of a small weight percentage of polysiloxane grafts. When such copolymers (or PSA compositions containing such copolymers) are coated on a sheet material or backing, a siliconized surface (e.g., silicone-rich surface) develops on exposure to a low surface energy surface such as air, and this provides for low initial peel adhesion values from both low and high energy substrate surfaces. Once applied to a substrate surface, adhesion builds with time to values approaching those of control materials containing no siloxane. Upon removal after a substantial residence time, the low initial peel adhesion surface can regenerate.

The surface characteristics of the co-polymeric adhesive composition can be chemically tailored through variation of both the molecular weight of the grafted siloxane polymeric moiety and the total siloxane content (weight percentage) of the copolymer, with higher siloxane content and/or molecular weight providing lower initial adhesion, i.e., a greater degree of positionability. The chemical nature and the molecular weight of the vinyl polymeric backbone of the copolymer can also be chosen such that the rate of adhesion build and the ultimate level of adhesion to the substrate can be matched to the requirements of a particular application. Longer-term positionability may thus be achieved if so desired. Since their siloxane content is relatively low, these copolymers can be readily compatible with siloxane-free polymers for example polymers of composition similar to that of the vinyl backbone. Thus, if blending of the copolymer with an unsiliconized PSA is desired, a backbone composition similar or identical to the chemical composition of the unsiliconized PSA may be selected so as to optimize compatibility and facilitate blending over a wide range of compositions.

The siloxane polymeric moieties can be grafted by polymerizing monomer onto reactive sites located on the backbone, by attaching preformed polymeric moieties to sites on the backbone, or by copolymerizing the vinyl monomer(s), A, and, when used, reinforcing monomer(s), B, with preformed polymeric siloxane monomer, C. Since the polymeric siloxane surface modifier is chemically bound, it is possible to chemically tailor the PSA compositions of this invention such that a specific degree of positionability is provided and can be reproduced with consistency. The initial adhesion properties of even highly aggressive PSA coatings can be varied over a broad range of values in a controlled fashion, and the need for an additional process step or steps for application of a physical spacing material is eliminated.

In some embodiments, the PSA composition can include a vinyl copolymer which is inherently tacky at the use temperature or which can be tackified, as known in the art, via the addition of a compatible tackifying resin or plasticizer. Monovalent siloxane polymeric moieties having a number average molecular weight above 500 can be grafted to the copolymer backbone. The copolymer can consists essentially of copolymerized repeating units from A and C monomers and, optionally, B monomers according to the description given herein.

The A monomer or monomers (there may be more than one) can be chosen such that a tacky or tackifiable material is obtained upon polymerization of A (or A and B). Representative examples of A monomers are the acrylic or methacrylic acid esters of non-tertiary alcohols such as methanol, ethanol, 1-propanol, 2-propanol, 1-butanol, 2-methyl-1-propanol, 1-pentanol, 2-pentanol, 3-pentanol, 2-methyl-1-butanol, 1-methyl-1-butanol, 3-methyl-1-butanol, 1-methyl-1-pentanol, 2-methyl-1-pentanol, 3-methyl-1-pentanol, cyclohexanol, 2-ethyl-1-butanol, 3-heptanol, benzyl alcohol, 2-octanol, 6-methyl-1-heptanol, 2-ethyl-1-hexanol, 3,5-dimethyl-1-hexanol, 3,5,5-trimethyl-1-hexanol, 1-decanol, 1-dodecanol, 1-hexadecanol, 1-octadecanol, and the like, the alcohols having from 1 to 18 carbon atoms with the average number of carbon atoms being about 4-12, as well as styrene, vinyl esters, vinyl chloride, vinylidene chloride, and the like. Such monomers are known in the art, and many are commercially available. In some embodiments, polymerized A monomer backbone compositions include poly(isooctyl acrylate), poly(isononyl acrylate), poly(isodecyl acrylate), poly(2-ethylhexyl acrylate), and copolymers of isooctyl acrylate, isononyl acrylate, isodecyl acrylate, or 2-ethylhexyl acrylate with other A monomer or monomers.

Representative examples of reinforcing monomer, B, are polar monomers such as acrylic acid, methacrylic acid, itaconic acid, acrylamide, methacrylamide, N,N-dimethylacrylamide, acrylonitrile, methacrylonitrile, and N-vinyl pyrrolidone. In addition, polymeric monomers or macromonomers (as will be described hereinafter) having a T_{g} or Tₘ above 20° C. are also useful as reinforcing monomers. Representative examples of such polymeric monomers are poly(styrene), poly(alpha-methylstyrene), poly(vinyl toluene), and poly(methyl methacrylate) macromonomers. In some embodiments, B monomers are acrylic acid, acrylamide, methacrylic acid, N-vinyl pyrrolidone, acrylonitrile, and poly(styrene) macromonomer. In illustrative embodiments, the amount by weight of B monomer does not exceed 20% of the total weight of all monomers such that excessive firmness of the PSA is avoided. In some embodiments, incorporation of B monomer to the extent of 2% to 15% by weight can provide a PSA of high cohesive or internal strength which also retains good adhesive properties.

The C monomer can have the general formula:
X(Y)_{b}Si(R)₃₋₍ₘ₊ₙ₎Zₘ
where X is a vinyl group copolymerizable with the A and B monomers, Y is a divalent linking group, n is zero or 1, m is an integer of from 1 to 3 such that m+n is not greater than 3; R is hydrogen, lower alkyl (e.g., methyl, ethyl, or propyl), aryl (e.g., phenyl or substituted phenyl), or alkoxy, and Z is a monovalent siloxane polymeric moiety having a number average molecular weight above about 500 and is essentially unreactive under copolymerization conditions.

The monomers are copolymerized to form the polymeric backbone with the C monomer grafted thereto and wherein the amount and composition of C monomer in the copolymer is such as to provide the PSA composition with a decrease (preferably of at least 20%) in the initial peel adhesion value relative to that of a control composition wherein the polysiloxane grafts are absent.

When the above-described PSA composition is coated on a backing and applied to a substrate surface, low initial adhesion to the substrate is observed. The level of adhesion and, thus, the degree of positionability are related, at least in part, to both the molecular weight of C and its weight percentage in the copolymer. Copolymers containing C monomer having a molecular weight less than about 500 are not very effective in providing positionability. Copolymers containing C monomer having a molecular weight greater than 50,000 effectively provide positionability, but, at such high molecular weights, possible incompatibility of the C monomer with the remaining monomer during the copolymerization process may result in reduced incorporation of C. C monomer molecular weight can range from about 500 to about 50,000. In some embodiments, a molecular weight can range from about 5,000 to about 25,000.

In some embodiments, the C monomer is incorporated in the copolymer in the amount of 0.01 to 50% of the total monomer weight to obtain the desired degree of positionability. The amount of C monomer included may vary depending upon the particular application, but incorporation of such percentages of C monomer having a molecular weight in the above-specified range has been found to proceed smoothly and to result in material which provides effective positionability for a variety of applications while still being cost effective. In general, it is desirable to have a decrease (preferably of at least 20%) in the initial peel adhesion value relative to that of a control containing no siloxane. It is of course possible, however, that a person skilled in the art might wish, for a specific purpose, to decrease the percent reduction in the initial peel as compared to the control.

In some embodiment, the total weight of B and C monomers is within the range of 0.01 to 70% of the total weight of all monomers in the copolymer.

In some embodiments, the C monomer and certain of the reinforcing monomers, B, are terminally functional polymers having a single functional group (the vinyl group) and are sometimes termed macromonomers or “macromers”. Such monomers are known and may be prepared by the method disclosed by Milkovich et al., as described in U.S. Pat. Nos. 3,786,116 and 3,842,059. The preparation of polydimethylsiloxane macromonomer and subsequent copolymerization with vinyl monomer have been described in several papers by Y. Yamashita et al., [Polymer J. 14, 913 (1982); ACS Polymer Preprints 25 (1), 245 (1984); Makromol. Chem. 185, 9 (1984)]. This method of macromonomer preparation involves the anionic polymerization of hexamethylcyclotrisiloxane monomer to form living polymer of controlled molecular weight, and termination is achieved via chlorosilane compounds containing a polymerizable vinyl group. Free radical copolymerization of the monofunctional siloxane macromonomer with vinyl monomer or monomers provides siloxane-grafted copolymer of well-defined structure, i.e., controlled length and number of grafted siloxane branches.

Silicone elastomers having polar moieties such as, for example, silicone polyureas (as described in U.S. Pat. No. 5,475,124, incorporated by reference herein) and radiation curable silicones (as described in U.S. Pat. No. 5,214,119, incorporated by reference herein) have silicone moieties that can concentrate at a low energy surface of the adhesive and form a siloxane-rich surface and upon rearrangement of the silicone moieties, builds adhesion. Once these silicone elastomers are laminated to another substrate, the siloxane moieties can migrate away from the siloxane-rich surface and allow adhesion between the adhesive (non-silicone polar moieties) and substrate to build over time. Silicone elastomers having polar moieties can optionally include additives such as, plasticizers, antioxidants, U.V. stabilizers, dyes, pigments, HALS, and the like.

After removal of the protective release liner, the microstructures on the surface of the adhesive layer retain their shape for a sufficient time to maintain the fluid egress properties of the adhesive layer. The selection of the adhesive also plays a role in determining the long-term properties of the adhesive layer. A pressure sensitive adhesive may be selected with rheological properties and surface characteristics such that the adhesive forces between the microstructured adhesive layer and the target second substrate are stronger than the elastomeric recovery forces of the portion of the microstructured adhesive deformed upon application of the coating to the second substrate. After pressure is applied, the microstructures on the adhesive layer substantially collapse and increase the amount of adhesive in contact with the second substrate.

Referring to FIG. 3, in some embodiments, after adequate application consistent with techniques known in the art, the channels 135 (shown in FIG. 2), if present, can at least partially disappear to provide the desired adhesion to the second substrates 130. The composite laminate 150 can obtain the desired optical property result described above.

FIG. 4 is a schematic cross-sectional view of the 120 and substrate 110 of FIG. 3 being removed from the second substrate 130. Following initial contact of the optical film with the second substrate 130, the optical film can be removed or repositioned without damaging the adhesive layer 120 or the second substrate 130. This film can be termed a “removed optical film.”

FIG. 5 is a schematic cross-sectional view of the removed optical film of FIG. 4 being laminated to the second substrate 130 to form a second composite laminate. The removed optical film of FIG. 4 can be laminated again onto the second substrate 130 to obtain the optical properties described above. As the optical film remains in contact with the second substrate 130, adhesion of the optical film to the second substrate builds over time.

In some embodiments, whether or not the microstructures on the adhesive layer are retained after initial application, the optical film can still be removed and relaminated to the second substrate defect free. This optical film can be laminated again on the second substrate and obtain a haze value of the second composite laminate of less than 15%, or less than 10%, or less than 5%, or less than 3%, as described above.

Laminating the siloxane-rich surface of the adhesive onto a second substrate (any number of times) provides an initial peel adhesion value between the siloxane-rich surface of the adhesive and second substrate. This initial peel adhesion value can be any useful value such as, for example, 0.1 to 30 oz/in, or 1 to 25 oz/in, or 1 to 20 oz/in. As the composite laminate ages over time, the peel adhesion value builds to a second peel adhesion value that is greater than the initial peel adhesion value. The second peel adhesion value can be at least 75% greater than the initial peel adhesion value, or at least 100% greater than the initial peel adhesion value, or at least 150% greater than the initial peel adhesion value, or at least 200% greater than the initial peel adhesion value, or least 300% greater than the initial peel adhesion value. The time interval needed to obtain a second peel adhesion value can range from a few minutes to a few days from the time of the dry laminating.

Optical films can be laminated to a second substrate with the adhesive to form a composite laminate. Some embodiments of composite laminates include composite laminates having a visible light transmission value in a range of 40% or greater and a total solar energy rejection value of 30% or greater, or a composite laminate having a visible light transmission value in a range of 50% or greater and a total solar energy rejection value of 35% or greater, or a composite laminate having a visible light transmission value in a range of 40% or greater and a total solar energy rejection value of 30% or greater, or a composite laminate having a visible light transmission value in a range of 50% or greater and a total solar energy rejection value of 35% or greater, or a composite laminate having a visible light transmission value in a range of 70% or greater and a total solar energy rejection value of 40% or greater. A partial listing of illustrative solar energy rejection films are described in WO 2000/11502, U.S. Pat. No. 3,681,179, U.S. Pat. No. 5,691,838, and WO 2001/79340, all inorporated by reference herein.

Advantages of the invention are illustrated by the following examples. However, the particular materials and amounts thereof recited in these examples, as well as other conditions and details, are to be interpreted to apply broadly in the art and should not be construed to unduly limit the invention.

### Methods

Luminous Transmittance and Haze

The luminous transmittance and haze of all samples were measured according to American Society for Testing and Measurement (ASTM) Test Method D 1003-95 (“Standard Test for Haze and Luminous Transmittance of Transparent Plastic”) using a TCS Plus Spectrophotometer from BYK-Gardner Inc., Silver Springs, Md.

Total Solar Energy Rejection

The percent of incident solar energy rejected by a glazing system equals solar reflectance plus the part of solar absorption which is reradiated outward. We calculate Total Solar Energy Rejected using the “WINDOW 5.2” program publicly available from Lawrence Berkeley National Lab. It is available from the following URL.
http://windows.lbl.gov/software/window/window.html

Transmittance and Reflectance spectra of the sample are measured using Perkin-Elmer Lambda 9 spectrophotometer. (PerkinElmer Life and Analytical Science, Inc., Boston, Mass.) WINDOW 5.2 is a publicly available computer program for calculating total window thermal performance indices (i.e. U-values, solar heat gain coefficients, shading coefficients, and visible transmittances). WINDOW 5.2 provides a versatile heat transfer analysis method consistent with the updated rating procedure developed by the National Fenestration Rating Council (NFRC) that is consistent with the ISO 15099 standard.

Peel Adhesion

The peel adhesion test is similar to the test method described in ASTM D 3330-90, substituting a glass substrate for the stainless steel substrate described in the test. Adhesive coated samples were cut into 1.27 cm by 15 cm strips. Each strip was then adhered to a 10 cm by 20 cm clean, solvent washed glass coupon using a 2 kg roller passed once over the strip. The bonded assembly dwelled at room temperature for about one minute and was tested for 180° peel adhesion using an IMASS slip/peel tester (Model 3M90, commercially available from Intrumentors, Inc., Strongville, Ohio) at a rate of 0.31 m/min (12 in/min) over a five second data collection time.

### EXAMPLES

Materials

IOA—isooctyl acrylate commercially available from Sigma Aldrich (Cat # 437425)
AA—acrylic acid commercially available from Sigma Aldrich
ACM—acrylamide commercially available from Sigma Aldrich (Cat # 148571)
14,000 PDMS diamine—an approximately 14,400 g/mol number average molecular weight polydimethylsiloxane diamine prepared as described in Example 2 of U.S. Pat. No. 5,461,134.
33,000 PDMS diamine—an approximately 32,300 g/mol number average molecular weight polydimethylsiloxane diamine prepared as described in Example 2 of U.S. Pat. No. 5,461,134.
IEM—2-isocyanatoethyl methacrylate available from Polysciences (Warrington, Pa.)
Darocur™ 1173—photoinitiator available from Ciba Specialty Chemicals, Tarrytown, Pa.
Kimoto Matte Film is a poly(ethylene terephthalate) (PET) film, approximately 0.005″ thick, with a matte hardcoat available from Kimoto Tech, Inc. (Cedartown, Ga.)
APB—Aminated polybutadienes as described in U.S. Pat. No. 3,661,874
SiMac and SiMac analogs—silicone macromonomers are commercially available from Shin-Etsu, Japan, and from 3M, St Paul, Minn.

### Example 1

### Radiation Curable Silicones

A 50:50 wt/wt blend of 33,000 PDMS diamine and 14,000 PDMS diamine was reacted with sufficient isocyanatoethyl methacrylate to ensure that all amine ends were reacted. Darocur™ 1173, 0.5% by wt, was added and mixed well. This mixture was coated onto 0.002″ (0.05 mm) PET film (Mitsubishi “SAC” two-sided primed film) using a knife coater set for a 0.002″ (0.05 mm) gap. This coating was covered with a release liner, ScotchPak™ Plain PET Film Type 860197, (available commercially from 3M, St Paul, Minn.), to exclude ambient oxygen. The sample was passed twice under a 300 w UV source at 15 ft/min to effect cure of the elastomer through the primed PET side. After the liner was removed, samples of the cured methacrylate-ureasiloxane adhesive were laminated to Kimoto Matte film and stored at room temperature until tested for 180° peel adhesion using an Imass SP-2000 Slip Peel tester (Accord, Mass.) The samples were tested every day for 8 days. The results are shown in Table 1.

TABLE 1

| Application to substrate (Day) | Average Peel Force (gm/in) |
|---|---|
| 0 (Initial) | 3.3 |
| 1 | 18.4 |
| 2 | 20.8 |
| 3 | 30.1 |
| 4 | 40.2 |
| 5 | Not tested |
| 6 | Not tested |
| 7 | 330 |
| 8 | 322.9 |

### Examples 2A and 2B

### Silicone Polyurea

### Example 2A

A blend of 33,000 PDMS diamine, 25 parts and 2-Methylpentamethylenediamine, 0.1 parts (DYTEK A®, from E.I. duPont de Nemours, Wilmington, Del.) was mixed in a solution of toluene (53 parts) and 2-propanol (22 parts) to form a 25% solids solution. This amine mixture was reacted with H12MDI (0.4 parts), (Desmodur W, bis(4-cyclohexylisocyanate) available from Bayer, Pittsburg, Pa.) The mixture was allowed to react until the H12MDI was consumed.

### Example 2B

was formed by mixing 60 parts of example 2A, 10 parts of 47 V1000 Rhodorsil Fluid (available from Rhodia Silicones, Cranbury, N.J.), 9 parts of 2-propanol and 21 parts of toluene.

Example 2A and Example 2B was coated onto a 0.002″ (0.05 mm) clear PET film with a standard Knife coater—using an 11 mil gap for 2A; and a 15 mil for 2B. Both examples were dried in forced air oven for 10 minutes at 70° C. These samples were tested for 180° peel performance against glass at 90 in/min as a function of dwell time and temperature on the glass substrate and on Kimoto Matte Hardcoated Film CG10 substrate. The results are reported in Table 2 below.

TABLE 2

| | | Initial | | |
|---|---|---|---|---|
| | | adhesion | 7 days @ | |
| Example | Substrate | (N/dm) | RT (N/dm) | 7 days at 70° C. |
| 2A | Glass | 0.30 | Adhesive | Adhesive |
| | | | cohesively | cohesively failed |
| | | | failed | |
| 2A | Kimoto Hard | 0.28 | 0.93 | Adhesive |
| | coat film | | | cohesively failed |
| 2B | Glass | 0.15 | 1.27 | Adhesive |
| | | | | cohesively failed |
| 2B | Kimoto Hard | 0.17 | 1.05 | Adhesive |
| | coat film | | | cohesively failed |

### Example 3

### Silicone Modified Acrylate Adhesive

Adhesives containing 0% SiMac (i.e., 96% IOA and 4% ACM; Comparative Adhesive Example); 1% SiMac (i.e., 95% IOA, 4% ACM, 1% SiMac; Example 4); 5% SiMac (i.e., 91% IOA, 4% ACM, 5% SiMac; Example 5); and 10% SiMac (i.e., 83% IOA, 7% AA, 10% SiMac; Example 6); were prepared as described in U.S. Pat. No. 4,693,935. The adhesives were coated onto 0.002″ (0.05 mm) clear PET film at approximately 0.8 grams/square foot (9.9 g/m²) dry adhesive coating weight. The coated PET was then dry laminated to a clean ⅛″ (3.2 mm) glass automobile window. Dry lamination was accomplished by manually applying the film to the glass surface and using a hard plastic squeegee to smooth out the film. Percent haze and transmission were determined immediately after the adhesive film was first laminated to the glass. The laminated film was then peeled away from the glass surface and reapplied using the same squeegee technique. Haze and transmission were determined following the reapplication. In one case, the silicone modified adhesive film was removed and reapplied within minutes of the initial application. In a second case, the silicone modified adhesive film was applied to and allowed to remain on the glass substrate for 16 hours before being removed and reapplied. The results are reported in Table 3.

TABLE 3

| | After Initial Application | | After One Reapplication | |
|---|---|---|---|---|
| Sample | % T | % H | % T | % H |

Immediate

| | | | | |
|---|---|---|---|---|
| 0% SiMAC | 88.7 | 4.4 | 88.5 | 4.9 |
| 5% SiMAC | 88.2 | 3.5 | 88.2 | 3.6 |

After 16 Hrs

| | | | | |
|---|---|---|---|---|
| 0% SiMAC | 88.7 | 4.3 | 87.9 | 8.1 |
| 5% SiMAC | 88.6 | 4.3 | 88.1 | 6.1 |

(Values represent average of three independent trials)

### Examples 4-6

### Adhesion of Microstructured Surfaces with Time

Portions of the formulations indicated for Examples 4-6 and the Comparative Adhesive Example were coated from a solvent solution onto both flat, non-microstructured liner and liners with square pyramidal microstructures. The properties of microstructures designated as “SS” and “DSS” are described in Table 4. The coated samples were dried at 70° C. for 10 minutes in a forced air oven. APB primed PET film (0.0015″; 0.038 mm) was laminated to the adhesive and the liners were removed to reveal the microstructured adhesive—a series of square pyramids rising from the plane of the adhesive with the same dimensions as the liner structures. The adhesive samples thus prepared were tested for 180° peel performance against glass at 90 in/min as a function of dwell time on the glass. The results are reported in Table 5.

TABLE 4

| | Pitch | Lines | Height | Slope |
|---|---|---|---|---|
| | (microns) | per/inch | (microns) | (degrees) |
| DSS | 290 | 87.5 | 25 | 10 |
| SS | 200 | 127 | 15 | 8.5 |

TABLE 5

| | | Dwell Time | Peel from glass | | | | | |
|---|---|---|---|---|---|---|---|---|
| | | to Glass | Flat | | SS | | DSS | |
| Example | Formulation | (hr) | Oz/in | N/dm | oz/in | N/dm | oz/in | N/dm |
| Comparative | 96:4 | 0 | 43.4 | 39.7 | 29.0 | 26.5 | 34.4 | 31.4 |
| (0% SiMac) | (IOA/ACM) | 1 | 58.6 | 53.6 | 45.6 | 41.7 | 42.2 | 38.6 |
| | | 2 | 57.8 | 52.8 | 43.2 | 39.5 | 40.2 | 36.7 |
| | | 5 | 55.6 | 50.8 | 45.2 | 41.3 | 37.2 | 34.0 |
| | | 24 | 55.6 | 50.8 | 50.4 | 46.1 | 51.2 | 46.8 |
| | | 48 | 56.2 | 51.4 | 53.2 | 48.6 | 51.0 | 46.6 |
| Ex 4 | 95:4:1 | 0 | 22.8 | 20.8 | 29.6 | 27.1 | 18.2 | 16.6 |
| | (IOA/ACM/SiMac) | 1 | 48.2 | 44.1 | 38.0 | 34.7 | 27.2 | 24.9 |
| | | 2 | 52.0 | 47.5 | 44.8 | 41.0 | 35.2 | 32.2 |
| | | 5 | 52.2 | 47.7 | 45.4 | 41.5 | 34.0 | 31.1 |
| | | 24 | 60.4 | 55.2 | 47.0 | 43.0 | 41.2 | 37.7 |
| | | 48 | 57.8 | 52.8 | 58.0 | 53.0 | 49.2 | 45.0 |
| Ex 5 | 91:4:5 | 0 | 8.4 | 7.7 | 9.6 | 8.8 | 7.6 | 6.9 |
| | (IOA/ACM/SiMac) | 1 | 40.2 | 36.7 | 31.2 | 28.5 | 18.2 | 16.6 |
| | | 2 | 40.4 | 36.9 | 34.0 | 31.1 | 18.8 | 17.2 |
| | | 5 | 41.6 | 38.0 | 36.8 | 33.6 | 23.0 | 21.0 |
| | | 24 | 56.2 | 51.4 | 44.4 | 40.6 | 41.8 | 38.2 |
| | | 48 | 55.8 | 51.0 | 52.4 | 47.9 | 42.4 | 38.8 |
| Ex 6 | 83:7:10 | 0 | 27.6 | 25.2 | 21.8 | 19.9 | 20.8 | 19.0 |
| | (IOA/AA/SiMac) | 1 | 85.0 | 77.7 | 40.2 | 36.7 | 27.4 | 25.0 |
| | | 2 | 86.2 | 78.8 | 47.0 | 43.0 | 31.2 | 28.5 |
| | | 5 | 90.6 | 82.8 | 52.6 | 48.1 | 36.6 | 33.5 |
| | | 24* | 112.4 | 102.7 | 76.2 | 69.7 | 44.0 | 40.2 |
| | | 48* | 107.6 | 98.4 | 85.8 | 78.4 | 52.8 | 48.3 |

Note:
Dry thickness of the above adhesives was 25 micrometers as shown in FIG. 3, element 120.
*Note:
at 24 and 48 hours, the adhesive of Example 6 coated onto the flat liner cohesively failed during the peel test. During the peel, adhesive remained on both the liner surface and the glass surface.

The complete disclosure of all patents, patent documents, and publications cited herein are incorporated be reference. The foregoing detailed description and examples have been given for clarity of understanding only. No unnecessary limitations are to be understood therefrom. The invention is not limited to the exact details shown and described, for variations obvious to one skilled in the art will be included within the invention defined by the claims.

We claim:

1. An optical film comprising:
an optical substrate; and
an adhesive having a first surface disposed on the optical substrate, the adhesive comprising siloxane moieties at a siloxane-rich second surface of the adhesive, wherein the siloxane-rich second surface increases adhesion when placed in contact with a second substrate over time.

2. An optical film according to claim 1, wherein the adhesive comprises pendant monovalent siloxane moieties.

3. An optical film according to claim 1, wherein the adhesive comprises silicone elastomers having polar moieties.

4. An optical film according to claim 2, wherein the pendant monovalent siloxane moieties have a number average molecular weight in a range from 500 to 50,000.

5. An optical film according to claim 1, wherein the adhesive comprises a microstructured siloxane-rich second surface.

6. An optical film according to claim 5, wherein the microstructured surface comprises a plurality of pyramidal projections extending away from the first surface, each projection having a mean height in a range of 1 to 30 micrometers and a mean pitch in a range of 50 to 400 micrometers.

7. An optical film according to claim 1, further comprising a second substrate disposed on the siloxane-rich second surface, wherein the adhesive is disposed between the optical film and the second substrate, forming a composite laminate.

8. An optical film according to claim 7, wherein the composite laminate has a haze value in a range of 15% or less.

9. An optical film according to claim 7, wherein the composite laminate has a haze value in a range of 10% or less.

10. An optical film according to claim 7, wherein the composite laminate has a visible light transmission value in a range of 40% or greater and a total solar energy rejection value of 30% or greater.

11. An optical film according to claim 7, wherein the composite laminate has a visible light transmission value in a range of 50% or greater and a total solar energy rejection value of 35% or greater.

12. An optical film according to claim 7, wherein the composite laminate has a visible light transmission value in a range of 70% or greater and a total solar energy rejection value of 40% or greater.

13. An optical film according to claim 7, wherein the composite laminate has a visible light transmission value in a range of 80% or greater.

14. An optical film according to claim 7, wherein the composite laminate has a visible light transmission value in a range of 90% or greater.

15. An optical film according to claim 7, wherein the composite laminate has a visible light transmission value in a range of 95% or greater.

16. A method comprising steps of:
providing an optical film comprising a optical substrate and an adhesive having a first surface disposed on the optical substrate, the adhesive comprising siloxane moieties at a siloxane-rich second surface of the adhesive;
laminating the siloxane-rich second surface onto a second substrate to form a first composite laminate, wherein the first composite laminate has an initial peel adhesion value;
allowing the siloxane-rich second surface to remain in contact with the second substrate for a time interval, wherein the first composite laminate has second peel adhesion value after the time interval and the second peel adhesion value is greater than the initial peel adhesion value.

17. A method according to claim 16, wherein the providing step comprises providing an optical film comprising an optical substrate and an adhesive having a first surface disposed on the optical substrate, the adhesive comprising siloxane moieties at a siloxane-rich second surface of the adhesive, wherein the siloxane-rich second surface comprises a microstructured surface.

18. A method according to claim 17, wherein the providing step comprises providing an optical film comprising an optical substrate and an adhesive, the siloxane-rich second surface having a plurality of pyramidal projections extending away from the first surface and each projection having a mean height in a range of 10 to 30 micrometers and a mean pitch in a range of 50 to 400 micrometers.

19. A method according to claim 16, further comprising the step of removing at least a portion of the optical film from the second substrate after the laminating step to form a removed optical film.

20. A method according to claim 19, further comprising the step of laminating the removed optical film onto the second substrate to form a second composite laminate.

21. A method according to claim 16, wherein the laminating step provides a first composite laminate having a haze value in a range of 5% or less.

22. A method according to claim 20, wherein the laminating step provides a second composite laminate having a haze value in a range of 10% or less.

23. A method according to claim 16, wherein the laminating step provides a first composite laminate having a visible light transmission value in a range of 40% or greater and a total solar energy rejection value of 30% or greater.

24. A method according to claim 16, wherein the laminating step provides a first composite laminate having a visible light transmission value in a range of 50% or greater and a total solar energy rejection value of 35% or greater.

25. A method according to claim 16, wherein the laminating step provides a first composite laminate having a visible light transmission value in a range of 40% or greater and a total solar energy rejection value of 30% or greater.

26. A method according to claim 16, wherein the laminating step provides a first composite laminate having a visible light transmission value in a range of 50% or greater and a total solar energy rejection value of 35% or greater.

27. A method according to claim 16, wherein the laminating step provides a first composite laminate having a visible light transmission value in a range of 80% or greater.

28. A method according to claim 16, wherein the laminating step provides a first composite laminate having a visible light transmission value in a range of 90% or greater.

29. A method according to claim 16, wherein the second peel adhesion value is at least 75% greater than the initial peel adhesion value.

30. A method according to claim 16, wherein the second peel adhesion value is at least 100% greater than the initial peel adhesion value.

31. A method according to claim 16, wherein the second peel adhesion value is at least 200% greater than the initial peel adhesion value.
